(19) United States
(12) Patent Application Publication
(10) Pub. No.: US 2021/0012724 A1
(43) Pub. Date: Jan. 14, 2021

(54) PIXEL UNIT AND DRIVE METHOD THEREOF AND DISPLAY APPARATUS

(71) Applicants: Beijing BOE Optoelectronics Technology Co., Ltd., Beijing (CN); BOE TECHNOLOGY GROUP CO., LTD., Beijing (CN)

(72) Inventor: Yunqi Wang, Beijing (CN)

(21) Appl. No.: 16/336,085

(22) PCT Filed: Sep. 27, 2018
(86) PCT No.: PCT/CN2018/107973

§ 371 Date: Mar. 22, 2019

(30) Foreign Application Priority Data
Jan. 2, 2018 (CN) 201810002924.3

(51) Int. Cl. G09G 3/34; G09G 3/36

(52) U.S. Cl. CPC G09G 3/3413; G09G 2320/064; G09G 3/3607

(57) ABSTRACT

A pixel unit includes a plurality of sub-pixels adjacently arranged in sequence. The plurality of sub-pixels are configured to alternately display different colors in time sequence. The plurality of sub-pixels include a first sub-pixel and a second sub-pixel, and the first sub-pixel and the second sub-pixel are configured to alternately display different colors.

### CROSS REFERENCE

This application is based on International Application No. PCT/CN2018/107973, filed on Sep. 27, 2018, which is based upon and claims the benefit and priority of Chinese Patent Application No. 201810002924.3 filed on Jan. 2, 2018, the entire content of which is incorporated herein by reference as a part of the present application.

### TECHNICAL FIELD

The present disclosure generally relates to the field of display technologies, and more particularly, to a pixel unit and a drive method thereof, and a display apparatus.

### BACKGROUND

Displaying a color image by a liquid crystal display (LCD) generally is implemented based on an additive color mixing principle of spatial color mixing. That is, sub-pixels corresponding to three primary colors (red color R, green color and blue color B) are arranged in a spatial plane at a high density indistinguishable to human eye spatial resolution, such that the color image is displayed by way of additive color mixing of lights with these color.

It is to be noted that the above information disclosed in this Background section is only for enhancement of understanding of the background of the present disclosure and therefore it may contain information that does not form the related art that is already known to a person of ordinary skill in the art.

### SUMMARY

The present disclosure is directed to a pixel unit and a drive method thereof and a display apparatus.

Other features and improvements of the present disclosure will become apparent from the following detailed description, or in part, by practice of the present disclosure.

According to an aspect of the present disclosure, there is provided a pixel unit. The pixel unit includes a plurality of sub-pixels adjacently arranged in sequence. The plurality of sub-pixels are configured to alternately display different colors in time sequence.

In an exemplary arrangement of the present disclosure, the plurality of sub-pixels include a first sub-pixel and a second sub-pixel, and the first sub-pixel and the second sub-pixel are configured to alternately display different colors.

In an exemplary arrangement of the present disclosure, within a period of one frame, the first sub-pixel is configured to display two colors of a red color, a green color and a blue color, the second sub-pixel is configured to display a third color among the red color, the green color and the blue color except the two colors displayed by the first sub-pixel, and within a period of a next frame, the first sub-pixel is configured to display the third color, and the second sub-pixel is configured to display the two colors.

In an exemplary arrangement of the present disclosure, the pixel unit further includes a liquid crystal layer and a backlight module.

The backlight module is configured to sequentially emit light of different colors within one frame period in time sequence.

In an exemplary arrangement of the present disclosure, the backlight module includes a light source and a drive circuit.

The light source includes a red light source, a green light source, and a blue light source.

The drive circuit is configured to acquire a control signal, and drive, based on the control signal, the red light source, the green light source and the blue light source to sequentially emit light within one frame period.

In an exemplary arrangement of the present disclosure, drive time of each sub-pixel includes liquid crystal response time and backlight display time. The liquid crystal layer is switched between an OFF state and an ON state within the liquid crystal response time, and the liquid crystal layer remains the ON state within the backlight display time.

In an exemplary arrangement of the present disclosure, an ON response curve and an OFF response curve of the liquid crystal layer are symmetrical.

In an exemplary arrangement of the present disclosure, the pixel unit further includes a drive circuit configured to drive the backlight module. As such, the backlight module can, within liquid crystal response OFF time of a sub-pixel, light corresponding to a color of another sub-pixel to compensate a brightness of another sub-pixel.

In an exemplary arrangement of the present disclosure, the ON response curve and the OFF response curve of the liquid crystal layer are asymmetrical.

In an exemplary arrangement of the present disclosure, the pixel unit further includes a brightness compensation module configured to dynamically regulate, based on a transmittance of the pixel unit detected within the liquid crystal response time, a light emission brightness of the backlight module to reduce a brightness fluctuation caused when different sub-pixels are switched.

According to an aspect of the present disclosure, there is provided a display apparatus, which includes the above-mentioned pixel unit.

According to an aspect of the present disclosure, there is provided a drive method of a pixel unit, which is used for driving the above display apparatus. The drive method includes controlling a plurality of sub-pixels adjacently arranged in sequence in the pixel unit to alternately display different colors in time sequence.

In an exemplary arrangement of the present disclosure, controlling a plurality of sub-pixels adjacently arranged in sequence in the pixel unit to alternately display different colors in time sequence includes controlling a backlight module to sequentially emit light of different colors within one frame period in time sequence, and driving each sub-pixel in the pixel unit to alternately transmit light of each color emitted by the backlight module.

In an exemplary arrangement of the present disclosure, controlling a backlight module to sequentially emit light of different colors within one frame period in time sequence includes controlling the backlight module to sequentially emit red light, green light and blue light within one frame period in time sequence.

In an exemplary arrangement of the present disclosure, when the pixel unit includes a first sub-pixel and a second sub-pixel, driving each sub-pixel in the pixel unit to alternately transmit light of each color emitted by the backlight module includes driving the first sub-pixel and the second sub-pixel to alternately transmit the light of the each color emitted by the backlight module.

In an exemplary arrangement of the present disclosure, drive time of each sub-pixel includes, in the same subframe, liquid crystal response time and backlight display time. The liquid crystal layer is switched between an OFF state and an ON state within the liquid crystal response time, and the liquid crystal layer remains the ON state within the backlight display time.

The method further includes controlling the backlight module to emit light of the same color within the liquid crystal response time and the backlight display time.

In an exemplary arrangement of the present disclosure, an ON response curve and an OFF response curve of the liquid crystal layer are symmetrical.

In an exemplary arrangement of the present disclosure, the drive method further includes emitting, by the backlight module within liquid crystal response OFF time of a sub-pixel, light corresponding to a color of another sub-pixel to compensate a brightness of another sub-pixel.

In an exemplary arrangement of the present disclosure, the ON response curve and the OFF response curve of the liquid crystal layer are asymmetrical.

In an exemplary arrangement of the present disclosure, the drive method further includes dynamically regulating, based on a transmittance of the pixel unit detected within the liquid crystal response time, a light source brightness of the backlight module to reduce a brightness fluctuation caused when different sub-pixels are switched.

It is to be understood that the above general description and the detailed description below are merely exemplary and explanatory, and do not limit the present disclosure.

### BRIEF DESCRIPTION OF THE DRAWINGS

The accompanying drawings herein are incorporated in and constitute a part of this specification, illustrate arrangements conforming to the present disclosure and together with the description serve to explain the principles of the present disclosure. Apparently, the accompanying drawings in the following description show merely some arrangements of the present disclosure, and persons of ordinary skill in the art may still derive other drawings from these accompanying drawings without creative efforts.

FIG. 1 schematically illustrates a schematic diagram of a pixel structure in the related art;

FIG. 2 schematically illustrates a schematic diagram of another pixel structure in the related art;

FIG. 3 schematically illustrates a distribution diagram of a sub-pixel in a pixel unit according to an exemplary arrangement of the present disclosure;

FIG. 4 schematically illustrates a schematic structural diagram of a pixel unit according to an exemplary arrangement of the present disclosure;

FIG. 5 schematically illustrates an operating timing diagram of a pixel unit according to an exemplary arrangement of the present disclosure; and

FIG. 6 schematically illustrates a flowchart of a drive method used in a display apparatus according to an exemplary arrangement of the present disclosure.

### DETAILED DESCRIPTION

The exemplary arrangement will now be described more fully with reference to the accompanying drawings. However, the exemplary arrangements can be implemented in a variety of forms and should not be construed as limited to the arrangements set forth herein. Rather, the arrangements are provided so that the present disclosure will be thorough and complete and will fully convey the concepts of exemplary arrangements to those skilled in the art. The features, structures, or characteristics described may be combined in one or more arrangements in any suitable manner. In the following description, numerous specific details are provided to give a full understanding of the arrangements of the present disclosure. Those skilled in the art will recognize, however, that the technical solution of the present disclosure may be practiced without one or more of the specific details described, or that other methods, components, materials, etc. may be employed. In other instances, well-known technical solutions are not shown or described in detail to avoid obscuring aspects of the present disclosure.

In addition, the accompanying drawings are merely exemplary illustration of the present disclosure, and are not necessarily drawn to scale. The thickness and shape of each layer in the drawings do not reflect the real proportion, which is only for ease of explaining the contents of the present disclosure. The same reference numerals in the drawings denote the same or similar parts, and thus repeated description thereof will be omitted.

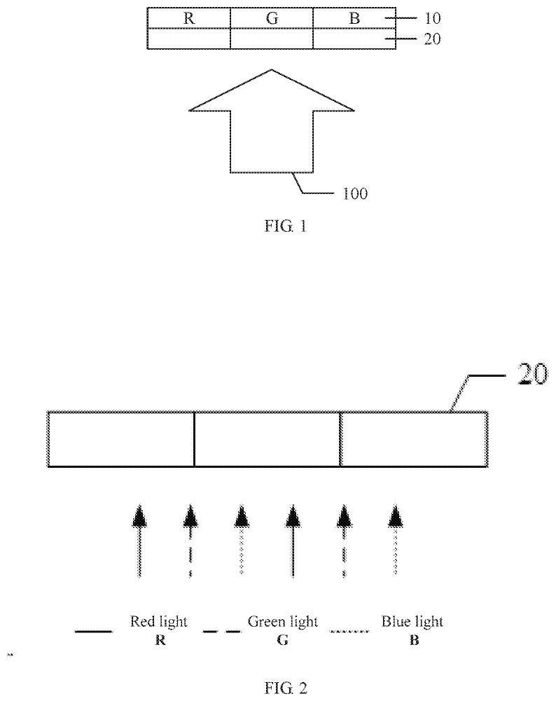

FIG. 1 illustrates a color image display apparatus implemented based on an additive color mixing principle of spatial color mixing. As shown in FIG. 1, in this display mode, generally it is required to filter white light 100 by using a color filter (CF) 10 to obtain a sub-pixel 20 corresponding to three-color light (R, and B). To enhance a utilization efficiency of light energy, a field sequential liquid crystal display based on an additive color mixing principle of temporal color mixing has been widely studied and applied. As shown in FIG. 2, the specific implementation of the field sequential liquid crystal display is as below: a red (R) backlight source, a green (G) backlight source and a blue (B) backlight source are employed to mix colors in a time axis. That is, an R image, a G image and a B image are rapidly switched in the time axis at a speed unperceivable to human eye time resolution, such that a color image is displayed by means of temporal color mixing. However, compared to the traditional spatial color mixing technology, if the same frame frequency is achieved using the temporal mixing technology, the frame frequencies of three subframes (R, and B) need to be increased by three times, wherein each subframe includes liquid crystal response time and light source turnon time. However, such a high frequency poses a serious challenge to the liquid crystal response and the design of the drive circuit.

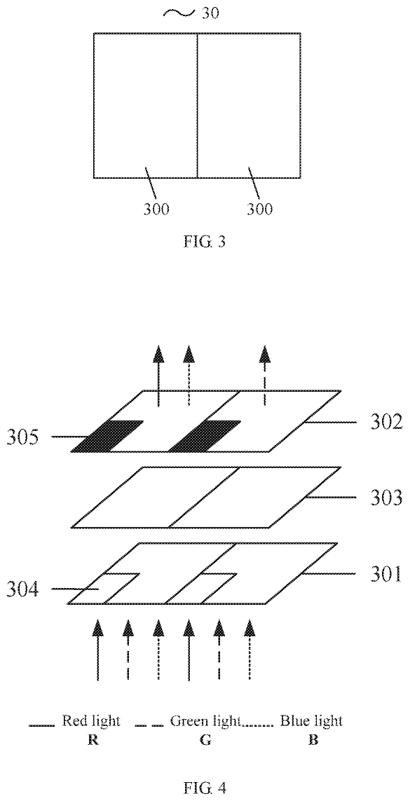

On this basis, this exemplary arrangement provides a pixel unit, which is applied to a field sequential liquid crystal display apparatus. As shown in FIG. 3, the pixel unit 30 may include a plurality of sub-pixels 300 adjacently arranged in sequence. The plurality of sub-pixels 300 are configured to alternately display different colors in time sequence. For example, the sub-pixels 300 may alternately transmit light emitted by the backlight module, such that displaying a pixel image is achieved. The backlight module is configured to sequentially emit light of different colors within one frame period in time sequence. For example, the backlight module may sequentially emit red light, green light and blue light in time sequence. As can be seen, any sub-pixel 300 only transmits light of a single color within a period of one subframe, but all the sub-pixels 300 can alternately transmit light of different colors within a period of one frame.

It is to be noted that light emitted by the backlight module should at least include red light R, green light G, and blue light B, and may further include light of other colors as required, for example, yellow light Y or white light W.

The pixel unit 30 provided by the exemplary arrangement of the present disclosure includes a plurality of sub-pixels 300. By controlling the plurality of sub-pixels 300 to be sequentially turned on under the cooperation of the backlight, the plurality of sub-pixels 300 may alternately transmit the light emitted by the backlight module. In this way, the display frequency of a single sub-pixel 300 can be effectively reduced on the basis of ensuring field sequential color display. In addition, the pixel unit 30 is simple in structure and well matches with an existing pixel structure and the fabrication process thereof, and thus the implementation difficulty is lower.

Based on the description of the above pixel unit 30, it can be known that each pixel unit 30 may include a plurality of sub-pixels 300. For example, two or three sub-pixels 300 may be arranged in one pixel unit 30. However, considering a larger number of sub-pixels 300 may have a certain adverse effect on pixels per inch (PPI), and two sub-pixels 300 working alternately are enough to achieve the effect of reducing the display frequency of a single sub-pixel 300, in this exemplary arrangement, preferably two sub-pixels 300 (i.e., a first sub-pixel and a second sub-pixel) are arranged in each pixel unit 30, such that the light emitted by the backlight module can alternately be transmitted through the two sub-pixels 300 t, thus implementing display of a pixel image.

For example, within a period of one frame, the first sub-pixel may be configured to display any two colors of a red color, a green color and a blue color; the second sub-pixel may be configured to display a third color among the red color, the green color and the blue color except the two colors displayed by the first sub-pixel; and within a period of a next frame, the first sub-pixel may be configured to display the third color, and the second sub-pixel may configured to display the any two colors. Therefore, display of the pixel image may be implemented by displaying different colors using the first sub-pixel and the second sub-pixel alternately.

In this exemplary arrangement, as shown in FIG. 4, the pixel unit 30 may include a first substrate 301 and a second substrate 302 opposite to each other, and a liquid crystal layer 303 positioned between the first substrate 301 and the second substrate 302. The first substrate 301 may include, for example, a thin-film transistor 304, a pixel electrode electrically connected to the thin-film transistor 304, and a first alignment layer arranged close to the liquid crystal layer 303. The second substrate 302 may include, for example, a black matrix 305 arranged with respect to the thin-film transistor 304, and a second alignment layer arranged close to the liquid crystal layer 303.

It is to be noted that the black matrix 305 being arranged with respect to the thin-film transistor 304 refers to a fact that an orthographic projection of the black matrix 305 on the first substrate 301 may completely cover an orthographic projection of the thin-film transistor 304 on the first substrate 301.

It is to be noticed that it is not required to arrange a color filter on the second substrate 302 in this exemplary arrangement. Because the pixel unit 30 provided in this arrangement operates based on the field sequential display principle, the backlight module may sequentially emit light of different colors in time sequence, for example, red light, green light, and blue light. That is, light emitted by the backlight module is color light, and thus color display can be achieved without additionally providing the color filter. Therefore, light loss caused by absorption of light by the color filter is avoided, and thus the utilization efficiency of the backlight is enhanced. In addition, a conventional LCD generally uses an R sub-pixel, a G sub-pixel and a B sub-pixel to mix color, and each pixel unit (i.e., pixel point) is represented by three sub-pixels. However, one pixel unit (i.e., pixel point) in this arrangement may be represented only by two sub-pixels. Therefore, in the case that the equivalent size and the equivalent pixel resolution, the area of a single sub-pixel may be increased by 1.5 times, such that the transmittance of light and the aperture ratio of a pixel can be significantly increased, and thus the utilization efficiency of light energy can be enhanced.

An exemplary description of the working principle of the pixel unit 30 is made below by taking a 60 Hz frame frequency commonly used by the LCD as an example with reference to the structure of the dual sub-pixel 300 as shown in FIG. 4. The backlight uses an RGB three-color light source. Arrows in the figure respectively represent red light R, green light G and blue light B emitted by the backlight module, and the display frequency of each of the three subframes (the red subframe, the green subframe and the blue subframe) is 180 Hz respectively, i.e., each subframe occupies about 5.56 ms. When each subframe is alternately displayed by using the structure of the dual sub-pixel 300 as shown in FIG. 4, the display frequency of each sub-pixel 300 is 90 Hz respectively.

FIG. 5 illustrates an operating timing diagram of the pixel unit 30. According to the existing field sequential display method, a backlight of a subframe is not turned on unless data of the subframe are written and liquid crystal molecule response is completed. Therefore, a display operation of each sub-pixel 300 may be divided into a liquid crystal (LC) response phase and a backlight display phase. However, in this exemplary arrangement, a working process of the pixel unit 30 includes liquid crystal response time and backlight display time. The liquid crystal layer is switched between an OFF state and an ON state within the liquid crystal response time, and the liquid crystal layer remains the ON state within the backlight display time. More specifically, the working process of the pixel unit 30 is as below.

In the display process of a first red subframe, the first sub-pixel such as the sub-pixel 300 on the left side of FIG. 4 is turned on after the liquid crystal response time, the backlight module outputs red light R at this moment, whereas a second sub-pixel such as the sub-pixel 300 on the right side of FIG. 4 remains off, and the pixel unit 30 is displayed as a red subframe in this phase.

In the display process of a second green subframe, the backlight module outputs green light G in the liquid crystal response phase, the first sub-pixel is turned off after the liquid crystal response time, whereas the second sub-pixel is turned on after the liquid crystal response time, and the pixel unit 30 is displayed as a green subframe in this phase.

In the display process of a third blue subframe, the backlight module outputs blue light B in the liquid crystal response phase, the second sub-pixel is turned off after the liquid crystal response time, whereas the first sub-pixel is turned on after the liquid crystal response time, and the pixel unit 30 is displayed as a blue subframe in this phase.

Timing sequences of subsequent subframes corresponding to different colors are the same as above, and thus their detailed descriptions are omitted herein.

The liquid crystal response generally needs to include an ON process and an OFF process. In this arrangement, a dual sub-pixel structure is adopted. In the process when the first sub-pixel is off, the second sub-pixel is controlled in response to be on. Supposing an ON response curve and an OFF response curve of the liquid crystal are symmetrical, the actual transmittance of the pixel unit (i.e., the sum of the transmittance of each sub-pixel) does not change. In this arrangement, on this basis, in a subframe period, the backlight is controlled to emit light of the same color in the liquid crystal response time as that the light emitted in the backlight display time. Therefore, since the backlight module can output light in the liquid crystal response phase, time required for waiting the liquid crystal to be on and off can be eliminated, and the display time can be shortened under the premise of ensuring the brightness, so as to implement the requirement of field sequential high display frequency.

It is to be noted that in this arrangement, the first red subframe is a beginning phase of display, and the other two subframes are not enabled. Therefore, the liquid crystal response process cannot be compensated, and the backlight needs to be turned on after the liquid crystal response is completed. For the subsequent subframes, a previous subframe and a next subframe may be mutually compensated, and thus the backlight can be turned on in the liquid crystal response phase.

More specifically, as shown in FIG. 5, in the first green subframe, the backlight is turned on in the liquid crystal response phase, such that the backlight is caused to emit green light. At this moment, the liquid crystal response process of the second sub-pixel is an ON phase, and meanwhile, the first sub-pixel is undergoing a liquid crystal response OFF process. Therefore, a part of the green light is emitted by the first sub-pixel, thus compensating for the brightness of the second sub-pixel in the liquid crystal response ON phase. That is, as shown in FIG. 5, the brightness of the first sub-pixel gradually decreases, but the brightness of the second sub-pixel gradually rises. At this moment, the total brightness of the pixel unit is maintained at a desired brightness.

On this basis, if according to the display content, it is required that the brightness of the red subframe is the same as that of the green subframe, but the actual ON time of the liquid crystal is less than the actual OFF time, the transmittance of the pixel unit may rise in the liquid crystal response process. In this case, compensation for brightness fluctuation may be implemented by appropriately reducing the brightness of the green backlight or increasing the rise time of the green backlight in the liquid crystal response process. Therefore, in the case that the liquid crystal response time is asymmetrical, the brightness fluctuation of the pixel unit may be compensated by adjusting the backlight.

In this way, display of the color image may be implemented by rapidly mixing the red light R, the green light G and the blue light B within time indistinguishable to human eye. In this arrangement, subframes of each color are alternately displayed by using the dual sub-pixel 300, the display frequency of each sub-pixel 300 can be significantly reduced, thus reducing the implementation difficulty of the field sequential liquid crystal display.

This exemplary arrangement further provides a display panel, which includes the foregoing pixel units 30. In the display panel, each of the pixel units 30 may include a plurality of sub-pixels 300, such as the dual sub-pixels 300. The plurality of sub-pixels 300 may be used for alternately transmitting light emitted by the backlight module, such that the display frequency of a single sub-pixel 300 can be effectively reduced on the basis of ensuring field sequential color display.

This exemplary arrangement further provides a display apparatus, which includes the above display panel and the backlight module, wherein the backlight module is configured to sequentially emit light of different colors within one frame period in time sequence.

It is to be noted that the light emitted by the backlight module should at least include red light R, green light G, and blue light B, and may further include light of other colors as required, for example, yellow light Y or white light W.

The display apparatus provided by this exemplary arrangement of the present disclosure can effectively reduce the display frequency of a single sub-pixel on the basis of ensuring field sequential color display. The display apparatus may be any product or component having a display function, such as a mobile phone, a tablet computer, a TV set, a notebook computer, a digital photo frame, a navigation device and so on.

In this exemplary arrangement, the backlight module may include a light source such as a light emitting diode (LED) light bar and a drive circuit. Herein, the LED light bar is used as a backlight to save energy.

Specifically, the light source such as the LED light bar should at least include a red light source such as a red LED light bar, a green light source such as a green LED light bar, and a blue light source such as a blue LED light bar. The drive circuit may be used for acquiring a control signal and driving, based on the control signal, the red light source, the green light source and the blue light source to sequentially emit light within one frame period.

In one arrangement, the LED light bar may be driven, for example, in three ways. That is, the red LED light bar is driven by a first way of drive circuit, the green LED light bar is driven by a second way of drive circuit, and the blue LED light bar is driven by a third way of drive circuit. In this case, when any way of drive circuit drives the corresponding LED light bar to emit light, for example, when the first way of drive circuit drives the red LED light bar to emit light, all the red LED light bars of the entire backlight module may be turned on.

In another arrangement, the LED light bar not only may be driven in route, but also may be further driven in block. That is, a group of LED light bars (including a red LED light bar, a green LED light bar, and a blue LED light bar) may correspond to one or more pixel units 30. In such a case, after the backlight is turned on, each of the LED light bars within an area may be driven, based on the area corresponding to the one or more pixel units 30, to emit light sequentially.

Further, considering the drive time of each sub-pixel 300 may include the liquid crystal response time and the backlight display time, and the rise time in the liquid crystal response time generally is less than the fall time, this may cause another subframe to be completely enabled before one subframe is fully disabled yet, thus causing brightness fluctuation when different sub-pixels 300 are switched.

On this basis, the display apparatus may further include a brightness compensation module. The brightness compensation module may dynamically adjust the light emission brightness of the backlight module based on the transmittance of the pixel unit 30 detected within the liquid crystal response time.

Specifically, in the liquid crystal response process, the display brightness of the pixel unit 30 may be expressed as L=(T1+T2)×BL, wherein BL represents the light emission brightness of the backlight, T1 and T2 respectively represent the transmittance of the first sub-pixel and the transmittance of the second sub-pixel. In this arrangement, the rise time in the liquid crystal response time generally is less than the fall time. Therefore, by actually measuring a liquid crystal transmittance curve, and by dynamically compensating for the backlight brightness based on the transmittance curve, the brightness fluctuation caused when different sub-pixels 300 are switched may be reduced, thus ensuring the pixel brightness stability.

This exemplary arrangement also provides a drive method of a pixel unit, which is used for driving the above pixel unit. The drive method may include: controlling a plurality of sub-pixels adjacently arranged in sequence in the pixel unit to alternately display different colors in time sequence.

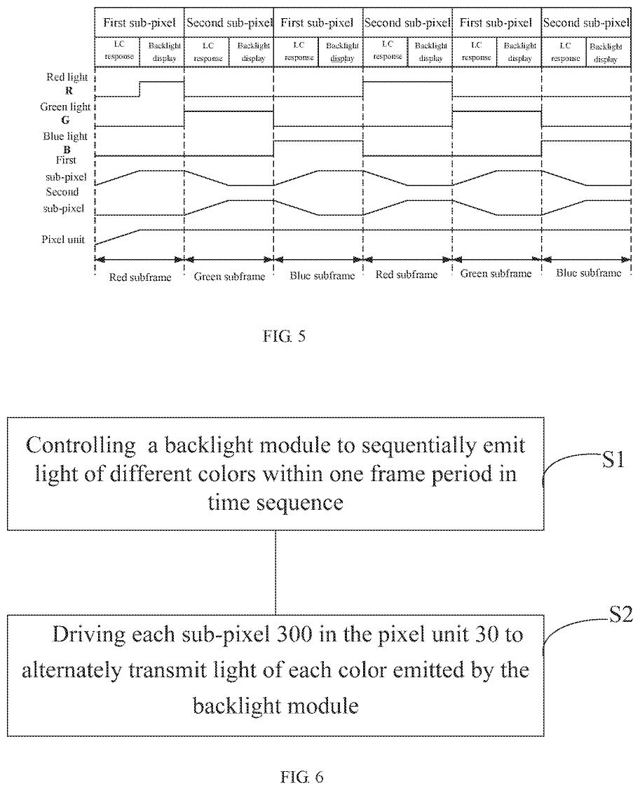

Specifically, as shown in FIG. 6, the drive method may include the following blocks.

Block S1: controlling a backlight module to sequentially emit light of different colors within one frame period in time sequence; and

Block S2: driving each sub-pixel 300 in the pixel unit 30 to alternately transmit light of each color emitted by the backlight module.

According to the drive method provided by the exemplary arrangement of the present disclosure, by controlling a plurality of sub-pixels 300 to be sequentially turned on under the cooperation of the backlight, the plurality of sub-pixels 300 may alternately transmit the light emitted by the backlight module. In this way, the display frequency of a single sub-pixel 300 can be effectively reduced on the basis of ensuring field sequential color display. In addition, the pixel unit 30 is simple in structure and well matches with an existing pixel structure and the fabrication process thereof, and thus the implementation difficulty is lower.

In this exemplary arrangement, light emitted by the backlight module should at least include red light R, green light and blue light B. In such a case, the controlling a backlight module to sequentially emit light of different colors within one frame period in time sequence may include: controlling the backlight module to sequentially emit red light R, green light G and blue light B within one frame period in time sequence.

In this exemplary arrangement, the pixel unit 30 may have a dual sub-pixel structure. For example, the pixel unit 30 only includes a first sub-pixel and a second sub-pixel. In such a case, the driving each sub-pixel 300 in the pixel unit 30 to alternately transmit light of each color emitted by the backlight module specifically may include: driving the first sub-pixel and the second sub-pixel to alternately transmit the light of each color emitted by the backlight module.

Considering the drive time of each sub-pixel 300 may include the liquid crystal response time and the backlight display time, and the rise time in the liquid crystal response time generally is less than the fall time, the drive method provided by this exemplary arrangement may further include:

S3: dynamically regulating, based on the transmittance of the pixel unit 30 detected within the liquid crystal response time, a light source brightness of the backlight module to reduce the brightness fluctuation caused when different sub-pixels 300 are switched.

The backlight module may emit light within, for example, the liquid crystal response time of the second sub-pixel, to compensate for the brightness of the first sub-pixel.

It is to be noted that specific details of the drive method have been described in detail in the corresponding pixel unit 30, and thus their detailed descriptions are omitted herein.

According to the pixel unit and the drive method thereof and the display apparatus provided by the exemplary arrangements of the present disclosure, by controlling a plurality of sub-pixels in the pixel unit to be sequentially turned on under the cooperation of the backlight, the plurality of sub-pixels may alternately transmit the light emitted by the backlight module. In this way, the display frequency of a single sub-pixel can be effectively reduced on the basis of ensuring field sequential color display. In addition, the pixel unit is simple in structure and well matches with an existing pixel structure and the fabrication process thereof, and thus the implementation difficulty is lower.

Other arrangements of the present disclosure will be apparent to those skilled in the art from consideration of the specification and practice of the disclosure described here. This application is intended to cover any variations, uses, or adaptations of the present disclosure following the general principles thereof and including such departures from the present disclosure as come within known or customary practice in the art. It is intended that the specification and arrangements be considered as exemplary only, with a true scope and spirit of the present disclosure being indicated by the appended claims.

It is to be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. A pixel unit comprising a plurality of sub-pixels adjacently arranged in sequence, wherein the plurality of sub-pixels are configured to alternately display different colors in time sequence, and
wherein the plurality of sub-pixels comprise a first sub-pixel and a second sub-pixel, and the first sub-pixel and the second sub-pixel are configured to alternately display different colors.

2. The pixel unit according to claim 1, wherein within a period of one frame, the first sub-pixel is configured to display two colors among a red color, a green color and a blue color, the second sub-pixel is configured to display a third color among the red color, the green color and the blue color except the two colors displayed by the first sub-pixel, and within a period of a next frame, the first sub-pixel is configured to display the third color, and the second sub-pixel is configured to display the two colors.

3. The pixel unit according to claim 1 further comprising a liquid crystal layer and a backlight module;
wherein the backlight module is configured to sequentially emit light of different colors within one frame period in time sequence.

4. The pixel unit according to claim 3, wherein the backlight module further comprises a light source and a drive circuit;
the light source comprises a red light source, a green light source, and a blue light source; and
the drive circuit is configured to acquire a control signal, and drive, based on the control signal, the red light source, the green light source and the blue light source to sequentially emit light within the one frame period.

5. The pixel unit according to claim 3, wherein drive time of each sub-pixel comprises liquid crystal response time and backlight display time, the liquid crystal layer is switched between an OFF state and an ON state within the liquid crystal response time, and the liquid crystal layer remains the ON state within the backlight display time.

6. The pixel unit according to claim 5, wherein an ON response curve and an OFF response curve of the liquid crystal layer are symmetrical.

7. The pixel unit according to claim 6 further comprising:
a drive circuit, configured to drive the backlight module such that the backlight module emits, within liquid crystal response OFF time of a sub-pixel, light corresponding to a color of another sub-pixel to compensate a brightness of another sub-pixel.

8. The pixel unit according to claim 5 further comprising:
a brightness compensation module, configured to dynamically regulate, based on a transmittance of the pixel unit detected within the liquid crystal response time, a light emission brightness of the backlight module to reduce a brightness fluctuation caused when different sub-pixels are switched.

9. A display apparatus comprising the pixel unit according to claim 1.

10. A drive method for driving a pixel unit comprising a plurality of sub-pixels adjacently arranged in sequence, wherein the plurality of sub-pixels are configured to alternately display different colors in time sequence, and wherein the plurality of sub-pixels comprise a first sub-pixel and a second sub-pixel, and the first sub-pixel and the second sub-pixel are configured to alternately display different colors,
the drive method comprising:
controlling one or more of the plurality of sub-pixels adjacently arranged in sequence in the pixel unit to alternately display different colors in time sequence;
wherein controlling one or more of the plurality of sub-pixels adjacently arranged in sequence in the pixel unit to alternately display different colors in time sequence comprises:
controlling a backlight module to sequentially emit light of different colors within one frame period in time sequence; and
driving each sub-pixel in the pixel unit to alternately transmit light of each color emitted by the backlight module.

11. The drive method according to claim 10, wherein controlling a backlight module to sequentially emit light of different colors within one frame period in time sequence comprises:
controlling the backlight module to sequentially emit red light, green light and blue light within one frame period in time sequence.

12. The drive method according to claim 10, wherein when the pixel unit comprises a first sub-pixel and a second sub-pixel, driving each sub-pixel in the pixel unit to alternately transmit light of each color emitted by the backlight module comprises:
driving the first sub-pixel and the second sub-pixel to alternately transmit the light of the each color emitted by the backlight module.

13. The drive method according to claim 10, wherein drive time of each of the plurality of sub-pixels comprises liquid crystal response time and backlight display time, the liquid crystal layer is switched between an OFF state and an ON state within the liquid crystal response time, and the liquid crystal layer remains the ON state within the backlight display time; and
the method further comprises: controlling the backlight module to emit light of the same color within the liquid crystal response time and the backlight display time.

14. The drive method according to claim 13, wherein an ON response curve and an OFF response curve of the liquid crystal layer are symmetrical.

15. The drive method according to claim 14 further comprising:
emitting, by the backlight module within liquid crystal response OFF time of a sub-pixel, light corresponding to a color of another sub-pixel to compensate a brightness of another sub-pixel.

16. The drive method according to claim 13 further comprising:
dynamically regulating, based on a transmittance of the pixel unit detected within the liquid crystal response time, a light source brightness of the backlight module to reduce a brightness fluctuation caused when different sub-pixels are switched.

17. A display apparatus comprising the pixel unit according to claim 2.

18. A display apparatus comprising the pixel unit according to claim 3.

19. The drive method according to claim 10, wherein within a period of one frame, the first sub-pixel is configured to display two colors among a red color, a green color and a blue color, the second sub-pixel is configured to display a third color among the red color, the green color and the blue color except the two colors displayed by the first sub-pixel, and within a period of a next frame, the first sub-pixel is configured to display the third color, and the second sub-pixel is configured to display the two colors.

20. The drive method according to claim 10, the pixel unit further comprising a liquid crystal layer and a backlight module;
wherein the backlight module is configured to sequentially emit light of different colors within one frame period in time sequence.
